(19) United States
(12) Patent Application Publication
(10) Pub. No.: US 2008/0290544 A1
(43) Pub. Date: Nov. 27, 2008

(54) Manufacture of Cement-Based Paving Articles

(76) Inventors: Peter Astrup Simmelsgaard, Tommerup (DK); Thomas Munch Laursen, Kolding (DK); Lasse Haahr Andersen, Tommerup (DK)

Correspondence Address: BANNER & WITCOFF, LTD., 1100 13th STREET, N.W., SUITE 1200, WASHINGTON, DC, 20005-4051, US

(21) Appl. No.: 11/883,748

(22) PCT Filed: Feb. 9, 2006
(86) PCT No.: PCT/EP2006/001307

§ 371 Date: Mar. 24, 2008

(30) Foreign Application Priority Data
Feb. 12, 2005 (GB) 0502976.4
Jun. 30, 2005 (DK) PA 2005 00974

(51) Int. Cl. B28B 1/08

(52) U.S. Cl. 264/69; 425/424

(57) ABSTRACT

A method for the production of a clay or cementitious construction unit, such as a paving block or slab, having a textured face surface, comprising contacting the intended face surface of an incompletely hardened, free-standing, self-supporting clay or cementitious construction unit (2), (3), with a water-absorbent porous membrane (6), for example of paper or other non-woven fibrous material, contacting the membrane-covered surface of the unit with the contact surface of a vibratable element (9), the contact surface of the vibratable element having a non-relief surface, or carrying a reverse image of a desired relief pattern to be applied to the face surface of the unit, vibrating the vibratable element with vibration head(s) (10), (11), (12) at a frequency greater than 14 KHz while it is in contact with the membrane-covered face surface of the unit, breaking contact between the textured face surface of the incompletely hardened unit and the membrane, and hardening the construction unit. Apparatus is also described, it which a lifting and lowering piston (4) lifts a tray (1) carrying the construction unit blanks into and out of contact with the membrane (61), the vibratable element (9) and the vibration head(s) (10), (11).

This invention relates to a method of making clay- or cement-based, principally concrete, construction units such as paving or facade bricks (also called blocks), slabs or tiles, having textured face surfaces.

### BACKGROUND TO THE INVENTION

It is often desirable for aesthetic or safety reasons that construction units should have textured face surfaces. From the aesthetic viewpoint, a textured surface resembling a natural stone or slate surface is often more attractive than a uniformly smooth surface. From a safety viewpoint, paving units such as paving slabs, blocks and tiles (also called “pavers”) should not have smooth face surfaces since they are slippery when wet, and can cause accidents. Furthermore, reflection from smooth paving is distracting and can be uncomfortable to the eye.

Construction units with textured surfaces, which are attractive to the eye, are of course known and in use.

Fired clay roofing tiles, and façade and paving bricks or blocks are examples of construction units with aesthetically pleasing textured surfaces. Their distinctive, finely textured surfaces result from their being cut by a cutting wire from clay, which has a very fine particle structure, with only very occasional larger particles. The fine particle structure allows the cutter wire to slide through the clay mass, while the few larger particles, (0.5-2 mm typically), are pushed and pulled to form a rough texture. It would be desirable to emulate that surface texture in a cheaper concrete block, to eliminate the energy intensive, and therefore expensive, firing step, and the shape or dimensional changes which the firing step sometimes causes. However, there are probably several reasons why no satisfactory method is currently known for the production of convincing concrete imitations of fired clay blocks, for example:
The wire cutting method cannot be used with concrete as concrete mostly consists of sand particles, often with larger aggregate chips. With concrete, the wire cutting method creates a very unsatisfactory uneven and fragile surface.
For rapid production rate, and for strength reasons, it would be desirable to make the concrete block from a minimum water-content concrete mix. This results in a stiff pre-cure blank into which it is difficult, if not impossible, to pressure-emboss any finely textured surface effect.
It is known to wet-cast concrete articles in a mould which has an embossed liner in its base, optionally with vibration of the mould to encourage intimate contact with the embossed liner. In principle this method might possibly enable the production of concrete paving blocks with the finely textured surface of fired-clay blocks, but wet casting is slow, costly, and results in articles with lower strength than minimum water-content mixes.

Also known and in use are surface textured concrete façade panels and paving slabs, also known as flagstones, for example mimicking the aesthetically pleasing textured surfaces of natural materials such as stone and slate. However; for convincing reproduction of natural texture, the method most commonly used in their production is wet casting into a mould with an embossed bottom liner, as discussed above, which has the disadvantages discussed. A satisfactory method for embossing texture onto a minimum water-content pre-cure slab appears not to be known, probably for same reasons as discussed above.

The present invention addresses and solves the problem of rapidly making textured-face construction units such as pavers, having tight dimensional tolerances and high strength, from minimum water-content cement mixes, especially concrete mixes. An essential element of the method is the use of high frequency vibration to impart texture to the surface of the stiff, pre-cure concrete blank.

Although it has been proposed to apply relief patterns to smooth concrete surfaces created with the aid of vibration, for example roofing and other tiles, (see for example WO 03/095168 and WO 03/095392), the creation of the necessary rough textured surfaces for pavers by the present method is believed novel and offers certain important advantages, referred to below. Furthermore, the methods of WO 03/095168 and WO 03/095392 are directed to the solution of a completely different problem, namely the emulation of smooth lacquer-like surface finishes, with optional relief patterns which necessarily form part of those smooth finishes. Those smooth finishes are in part a result of the formation of a thin film of water at the surface of the product during vibration, and best results are obtained if the smooth membrane is left in place during curing so that the water film disperses or evaporates. Removal of the smooth film before then tends to create bubbles and suction distortions as the film is peeled away, disturbing the smoothness of the finished product.

### BRIEF DESCRIPTION OF THE INVENTION

In contrast to the methods of WO 03/095168 and WO 03/095392, and other known surface treatment methods which have used vibration through smooth membranes to create surface finishes on clay or concrete construction units, this invention is based on the finding that use of a water absorbent membrane confers many advantages. For example, the water-absorbing membrane absorbs the liquid film formed on and in the surface of the product during vibration of the exposed surface thereof. Consequently, problems of low strength due to excessive water content and the change in the product's colour after a short time are avoided. Additionally, the use of a water-absorbing membrane remedies a drawback of the known use of plastics films, ie. that the plastics film cannot be removed immediately after the vibration. The above accumulation of water under the film and the close attachment between the film and the concrete surface cause the material to stick to the film, if this is removed immediately after vibration, whereby the product is not provided with the desired surface structure. As a result, the plastic film remains on the product during the hardening process, which may cause another problem, as the plastic film does not have the same properties as concrete when subjected to heat during the hardening. Consequently, the film often is loosened from portions of the product during hardening, which causes variations in colour in the finished product, as some portions of the products are covered and others are not. Uniform moisture conditions on the products are very important to ensure a homogeneous colour, which is not obtained when the products are not uniformly covered. This is a known problem in connection with arranging a plastic film as curing membrane on concrete floors or concrete panels.

The use of a plastic film on the samples is encumbered by the drawback that the plastic film protects the surface against contact with CO₂. Thus, when formed, the product has a surface with a high content of non-carbonized calcium hydroxide. Subsequently thereto, the smooth surface initiates the carbonation and start to fade/become lighter due to the carbonation.

### DETAILED DESCRIPTION OF THE INVENTION

The present invention provides a method for the production of a cementitious construction unit having a textured face surface, comprising
contacting the intended face surface of an incompletely hardened, free-standing, self-supporting clay or cementitious construction unit, with a water-absorbent porous membrane,
contacting the membrane-covered surface of the unit with the contact surface of a vibratable element,
the contact surface of the vibratable element being a non-relief surface, or carrying a reverse image of a desired relief pattern to be applied to the face surface of the unit,
vibrating the vibratable element while it is in contact with the membrane-covered face surface of the unit,
breaking contact between the textured face surface of the incompletely hardened unit and the membrane, and
hardening the construction unit.

The starting point for the method of the invention is an incompletely hardened, free-standing, self-supporting clay or cementitious construction unit, herein also referred to as a “pre-cure blank” or simply “blank”. “Cementitious” in this context means that the binder particles of the blank are cement, or are mainly cement particles, but the presence of other binder particles, such as fly ash and micro silica, is not excluded.

This pre-cure blank will usually be formed from a single aggregate-containing concrete mix. The aggregate may be, for example sand, or sand plus larger stone chips. Fibres of steel, glass or plastics material such as polyethylene may also be included. However the blank may also be formed of contiguous upper and lower layers of aggregate-containing concrete mix, the upper layer presenting the face surface of the paving unit and containing smaller sized aggregate than that of the lower layer. In the latter case, the concrete mix forming the upper layer of the unit is often referred to as the “face mix”.

The pre-cure blank will usually have been pressure-formed in a mould, from minimum water-containing, high strength, aggregate-containing concrete(s). This ensures that the blank meets the requirement that it be free-standing and self supporting, especially since in many cases the construction units in question, such as pavers, will generally be relatively thick, with a thickness of from about 35-80 mm.

In accordance with the invention, the intended face surface of the pre-cure blank is first contacted with a water-absorbent porous membrane. The use of such a membrane is an important feature of the invention. As will be discussed in more detail below, the high frequency vibration applied to the unit in accordance with the invention tends to draw water (often with dissolved salts and other potentially discolouring impurities) from the body of the unit to the vibrated face surface. The membrane beneficially absorbs a proportion of that water and dissolved impurities, minimising potential discolouration of the face surface of the finished unit. Furthermore, the interposition of the membrane between the face surface of the unit and the vibratable element reduces the suction effect during separation of the vibratable unit, making separation easier and minimising unwanted surface cavity and ridge formation on the face of the unit.

The water-absorbent, porous membrane may conveniently be paper-based sheet material such as wallpapers and crepe paper, as well as papers and other materials akin to absorbent cleaning materials such as paper kitchen towel material, or nonwoven absorbent sheet materials used in industry, offices, and the medical area, for wiping and mopping wet surfaces and objects or any other material having such characteristics. Such materials, with high absorbency and wet strength, are commercially available. Heavy decorative wallpapers, having an embossed relief pattern, are commercially available for domestic or industrial interior wall decoration. Such wallpapers are suitable for use as the water-absorbent, porous membrane in the method of this invention. In such cases, the embossed relief pattern may be transferred to the face surface of the blank. Water absorbent porous membranes are inherently easier than smooth plastic films to arrange in close conformity with the surface of the construction unit to be treated, and their fibrous nature enables them to deform and thus transfer relief patterns more faithfully than the most commonly available non-specialist smooth plastic membranes.

In accordance with one embodiment of the invention, the membrane-covered surface of the construction unit is next contacted with a vibratable element whose contact surface may be a non-relief surface or a relief surface which carries a reverse image of the desired textured face surface of the paver. Due to the use of the porous membrane, textured surfaces in the present context are not “smooth”. Whereas smooth surfaces are shiny and reflective, with few or no micro-indentations, textured surfaces created with the use of the porous membrane in accordance with the invention are rough or matt, with poor reflective properties and with a multitude of irregular micro- and indentations. Textured surfaces created by the present method may also have a visible relief pattern. For example, a surface which mimics natural stone or slate, or which carries a geometric or typographical relief pattern is thus also considered textured.

When the contact surface of the vibratable element has no relief pattern, the porous membrane itself may or may not have a relief pattern on its surface in contact with the blank. As mentioned above, wallpaper with or without a relief pattern is a convenient porous membrane material. Use of a vibratable element with a non-relief contact surface will transfer a copy of that surface to the face of the blank is the membrane also has no relief pattern, and otherwise will transfer the membrane relief pattern to the face surface of the blank.

When the contact surface of the vibratable element has a relief pattern, the porous membrane itself will normally not have a relief pattern on its surface in contact with the blank. In this case, the objective of the invention is to effectively transfer the relief surface of the vibratable element to the face surface of the blank.

In a modification of the invention, the water-absorbent porous membrane and the vibratable element may be one and the same, so that vibration is transmitted directly to the membrane and thence to the face surface of the blank. This modification is suitable, for example, when the membrane is of the embossed wallpaper type. Application of vibration to such a membrane causes the emboss pattern on the paper to be transferred to the blank, while the absorbency and porosity of the paper removes the water film which tends to accumulate on the face surface of the blank during vibration. Generally described, this modification of the method of the invention comprises:
contacting the intended face surface of the incompletely hardened, free-standing, self-supporting clay or cementitious construction unit, with a water-absorbent porous membrane,
the contact surface of the membrane having a non-relief surface, or carrying a reverse image of a desired relief pattern to be applied to the face surface of the unit,
vibrating the membrane, preferably at a frequency greater than 14 KHz while it is in contact with the face surface of the unit,
breaking contact between the textured face surface of the incompletely hardened unit and the membrane, and
hardening the construction unit.

In all cases, because the blank is free-standing and self-supporting, it will normally not be possible to use much pressure to assist surface vibration step, since pressure will tend to distort its dimensional tolerances or shape. A key finding of the invention is that high frequency vibration applied via the vibratable element promotes faithful transfer of the desired surface effect to the blank's face surface. Although knowledge of the mechanism which results in the satisfactory transfer is not itself necessary for the operation of the invention, it is believed that the vibration fluidizes the stiff mix of the blank to a small depth at the face surface, such fluidization promoting flow into close conformity with the membrane and contact surface of the vibratable element. It is this effect which tends to draw water to the surface of the blank, to be absorbed by the absorbent membrane as mentioned above.

In the embodiment of the invention which uses a vibratable element separate from the membrane, the vibratable element may be a flexible sheet, sized to cover and contact the face surface of the construction unit. It may also be formed of two parts two parts, namely (a) a flexible sheet, sized to cover and contact the face surface of the construction unit, and (b) a stiff backing, for example a backing plate, sized to cover and contact the flexible sheet while the latter is in contact with the face surface of the construction unit. In the latter case the stiff plate may simply be laid over the flexible sheet, or the flexible sheet laminated to the stiff plate, for example by adhesive. In either case, the flexible sheet may be of a material having the properties of natural or synthetic rubber, including silicone rubber, and may have a woven or non-woven mat embedded therein to impart added strength and thereby minimise potential tearing or other damage on handling.

In another, currently preferred, embodiment the vibratable element (again when separate from the membrane) is a stiff element, for example of stiff plastics material, such as polyurethane, or of metal.

In the case where the vibratable element is a flexible sheet, or is a flexible sheet backed by a stiff backing, a relief pattern on the contact surface of the flexible sheet may be created as a result of casting the material of the sheet in un-cured liquid form onto a textured surface which it is desired to imitate on the face surface of the paving unit. For example one or more layers of latex suspension of the rubber can be painted, sprayed or otherwise spread onto the original textured surface, and if necessary agitated until intimate contact with the original surface is achieved. Optionally, after at least one latex layer is applied, the woven or non-woven strengthening material may be applied, and further latex added to embed that material. After curing, the sheet may then be peeled from the original surface ready for use as the vibratable sheet in accordance with the invention. A release coating, for example of an oil or grease, may be applied to the original surface prior to casting the flexible sheet, to facilitate its removal when cured.

Similarly, when the vibratable element is stiff, a relief pattern on its contact surface may be created by working the surface to form the pattern, or by casting the material of the sheet in molten or un-cured liquid form onto a textured surface which it is desired to imitate on the face surface of the paving unit, then separating the resultant solidified or hard-cured element.

In accordance with the invention, the vibratable element, or the membrane (in the case when the membrane and vibratable element are one and the same), is vibrated. The frequency and amplitude of vibration will be chosen according to the surface finish required on the face surface of the blanks, and the consistency and composition of the blanks themselves. Generally frequencies of at least about 14 KHz, for example about 14 KHz to about 50 KHz, preferably about 14 KHz to about 26 KHz or about 14 KHz to about 21 KHz will be suitable. Suitable amplitudes of vibration will generally not be greater than 1 mm, and often no more than about 0.5 mm. The vibration time required for effective transfer of the relief or non-relief effect to the face surface of the blank will vary according to several factors, such as consistency and particle size of the cementitious mix at the face surface, the fineness of the desired texture effect from the membrane and relief or non-relief effect from the vibratable element, and the vibration frequency. In general it will be less than about 10 seconds, often less than about 5 seconds, and usually about 2-3 seconds.

It will often be convenient to vibrate the vibratable element by contacting it with one or more separate vibrating heads, often called “ultrasonic horns”. The vibrating head(s) may be arranged in contact with the vibratable element, but preferably they are either spaced apart from the vibrating element with the latter being capable of being brought into contact with them, or they are themselves movable into and out of contact with the vibratable element, However achieved, when the vibrating head(s) in contact with the vibratable element are energised, the vibrational energy is transferred to the vibratable element, through the absorbent membrane and thus to the face surface of the blank. Of course the vibrational energy is to some extent attenuated by the composition and material properties of the vibratable element and the membrane, but such attenuation may be compensated for by increasing the vibrational energy of the vibratable head(s) and/or the time of contact for vibration. To ensure substantially even energy transfer, vibrating head(s) are preferably sized to contact most of the surface area of the vibratable element (if used) or membrane (if a separate vibratable element is not used), or to traverse most of the non-contact surface of the vibratable element or membrane. In the case of construction units with a small face surface area, for example façade or paving blocks or smaller paving tiles, the vibrating head(s) may be shaped to have contact areas which corresponds (in the case of a single head) or together correspond (in the case of multiple heads) to that of the face surface of the blank.

In one embodiment of the invention a powder (including fine granular) material, such as a colour pigment or other visual effect material such as mica, or hard wearing material such as carborundum, bauxite powder, steel or glass powders, may be applied to the surface of the pre-cure blank prior to application of the absorbent membrane. The powder becomes incorporated in the face surface of the construction unit during the vibration step, and thus modifies the surface properties of the resultant product.

After vibrational treatment in accordance with the invention, the vibratable element (when used) and membrane are separated from the unit, and the unit is hardened.

In a preferred embodiment of the invention, two or more of the incompletely hardened construction units are simultaneously covered with one sheet, or a section of a longer length of absorbent membrane and a one-piece vibratable element is contacted with the membrane-covered faces of the units, for vibration with a plurality of vibrating heads. For example, a plurality of pre-cure units may be transported on a tray to an operating station, where a continuous sheet of the absorbent membrane is extended horizontally between dispensing and collection rollers. A fixed one-piece vibratable element may be positioned above the stretched expanse of membrane between the rollers, and an array of vibrating heads may be arranged above, and for contact with, contact with the vibratable element. At the operating station, the tray of pre-cure units may be lifted up into contact with the stretched section of membrane, thereby covering the face surfaces of the units with membrane. If the vibratable element is not at this stage in contact with the stretched expanse of the membrane, the upward movement of the tray of pre-cure units with the membrane covering may be continued until such contact is established. Likewise, if not already in contact with the vibratable element, the continued upward movement of the tray brings the reverse side of the vibratable element into contact with the vibrating heads. Alternatively the array of vibrating heads may be brought down into contact with the vibratable element. After vibration via the vibrating heads, the tray of units may be lowered out of contact with the membrane and vibratable element, and transported away from the operating station for hardening the units. The dispensing and collection rollers may then be rotated to expose a fresh expanse of membrane at the operating station, and a new tray of units may be transported to the operating station where the method of the invention may be repeated. The cycle time for such an operation is potentially short—for example about 5 seconds for the transport of the plate of units to the station, about 10 seconds for the plate lift, vibration and plate descent stage.

The method of the invention allows the production of high strength concrete construction units with textured and optionally relief-patterned face surfaces. Since they are formed from free-standing pre-cure blanks rather than by slow wet casting, high production rates are possible at a lower cost.

The method of the invention also allows the formation of cementitious construction units with both novel and traditional textured and relief patterned face surfaces. A particular advantage derives from its ability to create face effects on concrete construction units which closely resemble those of naturally occurring materials such as stone and slate. In an especially useful aspect, the effect may be that of a traditionally formed fired-clay paving brick, since it is a simple matter to cast a flexible sheet vibratable element from such a clay brick, and transfer it to a concrete blank as described above.

Another advantage of the invention lies in its ability to produce construction units to high dimensional tolerances. As described above, the transfer of the texture from the vibratable embossing element is done with very little applied pressure, hence the dimensions of the blank are not significantly disturbed by the method of the invention, and the clay or cement mix cures with very little distortion. The resultant high-tolerance construction units are thus well adapted for accurate laying. This is a particular advantage in the case of paving bricks, since the traditional fired clay paving bricks are very often distorted by the firing process, and are not generally adapted for accurate machine laying methods.

Another advantage of the method of the invention lies in the ease with which one vibratable element may be swapped for another, allowing rapid switching from production of one type of unit to another.

Apparatus for carrying out the process of the invention generally comprises, in vertical alignment
(i) support means for at least one incompletely hardened, free-standing, self-supporting clay or cementitious construction unit,
(ii) a water-absorbent porous membrane extending over the construction unit support means,
(iii) optionally a vibratable element extending over the membrane and having a non-relief surface, or carrying a reverse image of a desired relief pattern to be applied to the face surface of the at least one construction unit,
(iv) vibrating means for vibrating the vibratable element, preferably at a frequency greater than 14 KHz,
   the apparatus also comprising means for making and breaking contact between the surface of said construction unit, the membrane, the optional vibratable element, and the vibration means.

The requirement that the water-absorbent porous membrane extends over the construction unit support means, implies that at least the face surfaces of the blanks to be treated will be brought into contact with the membrane (and the vibratable element, when present) by the means for making and breaking contact between the surface of said construction unit, the membrane, the optional vibratable element, and the vibration means. In most cases this may be achieved by arranging for the membrane to extend over the whole area of the support means, but it is enough that it extend at least over the areas of the face surfaces of the blanks to be treated.

An embodiment of the invention will now be described further with reference to the drawings, wherein:

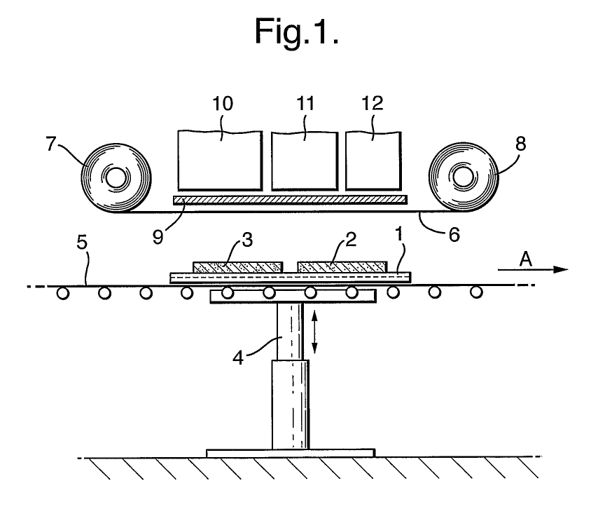

FIG. 1 is a diagrammatic cross-sectional view of one type of apparatus for carrying out the method of the invention.

In FIG. 1, a square or rectangular tray 1 supports an array of incompletely cured free-standing, self-supporting concrete paving brick or slab blanks, two of which are suggested in cross section at 2 and 3. The intended face surfaces of the blanks face upwards. These bricks or slabs have been pressure moulded and removed from their moulds. Optionally, on their upper faces a cement-based powder may be applied. As an alternative to the powder, a cement-based layer, eg. micro mortar, may be applied. The tray carrying the blanks is transported in the direction of the arrow A on spaced apart parallel rails, wheel trains or belts (hereafter called transport rails or simply rails), one of which is indicated as 5. A piston-driven lifting and lowering device 4, adapted for upward and downward movement as indicated by the double headed arrow, is mounted on the ground between the transport rails 5. In the FIGURE, the rails 5 have transported the tray of blanks to the operating station for the method of the invention and have temporarily halted there. The transport rails can carry a plurality of trays of blanks sequentially to and from the operating station.

Arranged above the tray of blanks at the operating station is an expanse 6 of water absorbent unembossed paper membrane forming part of a continuous roll dispensed from roller 7 and collected on roller 8. The rollers are halted while the tray of blanks is at the operating station. Above and either in contact with or spaced from the stretched expanse of membrane by a few mm or cm is a fixed vibratable element 9 in the form of a silicone rubber mat or a stiff polyurethane casting, the lower face of which carries a relief pattern and the upper face of which is smooth. In the case of a flexible mat 9, the mat is removably clamped in position by clamping means (not shown), or removably mounted on a fixed backing plate (also not shown). In the case of a stiff polyurethane casting 9, the casting is also clamped in position. An array of ultrasonic horns, three of which are suggested in cross section at 10, 11 and 12, is fixed in position above and spaced away from the upper surface of the vibratable element 9 by a few millimetres. When the vibratable element is lifted, or flexes upwards under upward pressure, into contact with the horn array, the contact area between the horn array and the vibratable element is substantially the same as that of the array of blanks on the tray.

In the method of the invention, the tray carrying the blanks is moved into and halted at the operating station below the expanse 6 of absorbent membrane stretched between rollers 7 and 8, which are at a halt at this stage. The vibrating horn array (10, 11, 12) is not energised at this stage. The piston 4 now raises the tray carrying the blanks into contact with the membrane expanse 6 and then into contact with the relief patterned lower face of the vibratable element 9, so that the face surfaces of the blanks are covered by the membrane and the relief surface of the mat is in contact with the membrane. Continuing upward movement flexes the upper surface of the vibratable element into contact with the horn array. The horn array is energised, vibrating at a frequency of between 14 and 50 KHz for about 2 to 10 seconds depending on the concrete mix/or face mix, frequency, amplitude and pressure applied when vibrating. The water absorbent membrane absorbs water accumulating at the surface of the paving brick during the vibration. During the vibration step, the relief surface of the mat is embossed on the face surface of the paving brick. The piston then lowers the tray carrying the now surface-treated blanks onto the transport rails. Contact between the horn array and the upper surface of the vibrating element is broken as the latter flexes on release of upward pressure. The transport rails then transport the tray of treated blanks away from, and a new tray of untreated blanks into, the operating station, while the rollers wind the membrane supply on to position a fresh expanse of membrane between the rollers. The process is then repeated.

In the illustrated embodiment, the vibratable element (9) has a relief pattern on its lower face, and the absorbent paper membrane 6 is unembossed. In an alternative embodiment, the vibratable element (9) has no relief pattern on its lower face, and the absorbent paper membrane 6 is embossed. In this alternative embodiment, the vibration step transfers the membrane emboss pattern to the surface of the paving brick while water accumulating on the surface is absorbed by the paper.

In another embodiment of the invention, the vibratable element is removed and the absorbent paper is vibrated directly by the ultrasonic horns. This may especially be the case when using wallpaper as the absorbent material.

The above described and illustrated apparatus may be regarded as comprising, in vertical alignment from bottom to top,
(i) piston driven lifting and lowering means (4),
(ii) support means (1) for at least one incompletely hardened, free-standing, self-supporting clay or cementitious construction unit,
(iii) a water-absorbent porous membrane (6) extending over the construction unit support means,
(iv) optionally, a vibratable element (9) having a non-relief surface, or carrying a reverse image of a desired relief pattern to be applied to the face surface of the at least one construction unit,
(v) vibrating means (10), (11), (12) for vibrating the vibratable element, preferably at a frequency greater than 14 KHz,
   wherein the lifting and lowering means (4) is adapted to lift the construction unit support means (1) carrying at least one construction unit (2), (3), thereby bringing into contact the surface of said construction unit, the membrane (6) the optional vibratable element (9) and the vibration means (10), (11), (12), and then

to lower the construction unit support means (1), thereby breaking contact between the vibration means (10), (11), (12), the optional vibratable element (9), the membrane (6), and the construction unit (2), (3).

In the illustrated embodiment, the vibrating element (10), (11), (12) is fixed and the piston driven lifting and lowering means (4) brings the assembly into contact for the vibration step. In an alternative embodiment, the tray (1) is essentially held in position, with little or no upward or downward movement capability, and it is the vibrating element (10), (11), (12) which moves downwards or upwards to bring the assembly into contact for the vibration step. This alternative embodiment of the invention may be regarded as comprising, in vertical alignment from bottom to top,
(i) support means (1) for at least one incompletely hardened, free-standing, self-supporting clay or cementitious construction unit,
(ii) a water-absorbent porous membrane (6) extending over the construction unit support means,
(iii) optionally, a vibratable element (9) having a non-relief surface, or carrying a reverse image of a desired relief pattern to be applied to the face surface of the at least one construction unit,
(iv) vibrating means (10), (11), (12) for vibrating the vibratable element, preferably at a frequency greater than 14 KHz,
   wherein the vibrating means is adapted to be lifted and lowered relative to the optional vibratable element and the membrane whereby when lowered into contact with the optional vibratable element, or the membrane if the vibratable element is not present, the membrane is urged into contact with the surface of said construction unit; and whereby when lifted contact between the vibrating means, the optional vibratable element, the membrane, and the construction unit is broken.

1. A method for the production of a clay or cementitious construction unit having a textured face surface, comprising
contacting the intended face surface of an incompletely hardened, free-standing, self-supporting clay or cementitious construction unit, with a water-absorbent porous membrane,
contacting the membrane-covered surface of the unit with the contact surface of a vibratable element,
the contact surface of the vibratable element having a non-relief surface, or carrying a reverse image of a desired relief pattern to be applied to the face surface of the unit,
vibrating the vibratable element while it is in contact with the membrane-covered face surface of the unit,
breaking contact between the textured face surface of the incompletely hardened unit and the membrane, and
hardening the construction unit.

2. A method as claimed in claim 1 wherein the vibratable element is vibrated at a frequency of greater than 14 KHz.

3. A method as claimed in claim 1 wherein the incompletely hardened, unit comprises contiguous upper and lower layers of aggregate-containing concrete mix, the upper layer presenting the face surface of the unit and containing smaller sized aggregate than that of the lower layer.

4. A method as claimed in claim 1 wherein a powder is applied to the intended face surface of the unit prior to contacting the face with the water-absorbent porous membrane.

5. A method as claimed in claim 1 wherein the vibratable element is a flexible sheet, sized to cover and contact the face surface of the paving unit.

6. A method as claimed in claim 1 wherein the vibratable element is in two parts, namely (a) a flexible sheet, sized to cover and contact the face surface of the unit, and (b) a stiff plate, sized to cover and contact the flexible sheet while the latter is in contact with the face surface of the unit.

7. A method as claimed in claim 5 wherein the flexible sheet is of natural or synthetic rubber, including silicone rubber.

8. A method as claimed in claim 7 wherein the flexible sheet has a woven or non-woven mat embedded therein.

9. A method as claimed in claim 1 wherein the vibratable element is stiff, and is sized to cover and contact the face surface of the paving unit.

10. A method as claimed in claim 1 wherein the contact surface of the vibratable element carries a reverse image of a desired relief pattern to be applied to the face surface of the unit,

11. A method as claimed in claim 1 wherein the contact surface of the vibratable element carries no relief pattern.

12. A method as claimed in claim 1 wherein the water-absorbent, porous membrane is of paper.

13. A modification of the method as claimed in claim 1 wherein the water-absorbent porous membrane also constitutes the vibratable element, whereby the method comprises:
contacting the intended face surface of the incompletely hardened, free-standing, self-supporting clay or cementitious construction unit, with a water-absorbent porous membrane,
the contact surface of the membrane having a non-relief surface, or carrying a reverse image of a desired relief pattern to be applied to the face surface of the unit,
vibrating the membrane while it is in contact with the face surface of the unit,
breaking contact between the textured face surface of the incompletely hardened unit and the membrane, and
hardening the construction unit.

14. A method as claimed in claim 1 wherein the vibratable element is vibrated by one or more vibrating heads in contact with or capable of being brought into and out of contact with, the vibratable element.

15. A method as claimed in claim 1 wherein the construction unit is a paving block, brick, tile, or slab; or a facade panel, tile, block or brick; or a roofing panel or tile.

16. Apparatus for the surface treatment of clay or cementitious construction units comprising, in vertical alignment
(i) support means for at least one incompletely hardened, free-standing, self-supporting clay or cementitious construction unit,
(ii) a water-absorbent porous membrane extending over the construction unit support means,
(iii) optionally a vibratable element extending over the membrane and having a non-relief surface, or carrying a reverse image of a desired relief pattern to be applied to the face surface of the at least one construction unit,
(iv) vibrating means for vibrating the vibratable element,
the apparatus also comprising means for making and breaking contact between the surface of said construction unit, the membrane, the optional vibratable element, and the vibration means.

17. Apparatus as claimed in claim 16 comprising, in vertical alignment from bottom to top,
(i) piston driven lifting and lowering means (4),
(ii) support means (1) for at least one incompletely hardened, free-standing, self-supporting clay or cementitious construction unit,
(iii) a water-absorbent porous membrane (6) extending over the construction unit support means,
(iv) optionally, a vibratable element (9) having a non-relief surface, or carrying a reverse image of a desired relief pattern to be applied to the face surface of the at least one construction unit,
(v) vibrating means (10), (11), (12) for vibrating the vibratable element,
wherein the lifting and lowering means (4) is adapted to lift the construction unit support means (1) carrying at least one construction unit (2), (3), thereby bringing into contact the surface of said construction unit, the membrane (6) the optional vibratable element (9) and the vibration means (10), (11), (12), and then
to lower the construction unit support means (1), thereby breaking contact between the vibration means (10), (11), (12), the optional vibratable element (9), the membrane (6), and the construction unit (2), (3).

18. Apparatus as claimed in claim 16 comprising in vertical alignment from bottom to top,
(vi) support means (1) for at least one incompletely hardened, free-standing, self-supporting clay or cementitious construction unit,
(vii) a water-absorbent porous membrane (6) extending over the construction unit support means,
(viii) optionally, a vibratable element (9) having a non-relief surface, or carrying a reverse image of a desired relief pattern to be applied to the face surface of the at least one construction unit,
(ix) vibrating means (10), (11), (12) for vibrating the vibratable element,
wherein the vibrating means is adapted to be lifted and lowered relative to the optional vibratable element and the membrane whereby when lowered into contact with the optional vibratable element, or the membrane if the vibratable element is not present, the membrane is urged into contact with the surface of said construction unit; and whereby when lifted contact between the vibrating means, the optional vibratable element, the membrane, and the construction unit is broken.

19. Apparatus as claimed in claim 16 wherein the construction unit support means is carried on conveying means (5) capable of delivering it to and carrying it from a position below the vibrating means (10), (11), (12).

20. Apparatus as claimed in claim 16 wherein the membrane (6) extends as a continuous sheet between dispensing and collection rollers (7), (8), capable of winding a length of the sheet from the dispensing roller onto the collection roller prior to lifting and lowering cycles of the apparatus.

21. Apparatus as claimed in claim 16 wherein the vibratable element is vibratable at a frequency of greater than 14 KHz.
